(19) United States
(12) Patent Application Publication
(10) Pub. No.: US 2009/0309833 A1
(43) Pub. Date: Dec. 17, 2009

(54) INPUT CONTROLLER USED TOGETHER WITH POINTING DEVICE AND INPUT CONTROL METHOD

(75) Inventor: Hiroshi Nakamura, Tokorozawa-Shi (JP)

Correspondence Address: YOUNG & THOMPSON, 209 Madison Street, Suite 500, Alexandria, VA, 22314, US

(73) Assignee: PIONEER CORPORATION, Tokyo (JP)

(21) Appl. No.: 12/374,687

(22) PCT Filed: Jul. 26, 2006
(86) PCT No.: PCT/JP2006/314767

§ 371 Date: Feb. 5, 2009

(51) Int. Cl. G06F 3/033

(52) U.S. Cl. 345/162

(57) ABSTRACT

Coordinate data on a position pointed out by a pointer on a screen is stored in a storage section. When a control switch (ball) is depressed, the coordinate data corresponding to a moment before a predetermined time counted substantially from the moment when the control switch is depressed is read from the storage section and a processing associated with the pointed position corresponding to the coordinate data is performed.

### TECHNICAL FIELD

The present invention relates to an input control apparatus for and an input control method of displacing a pointer or highlight or the like on a screen in accordance with the operation of a pointing device and performing a process indicated by the pointer or highlight.

### BACKGROUND ART

A graphic user interface (GUI) is widely used for personal computers. In recent years, the graphic user interface has been also used for AV (Audio-Visual) equipment such as DVD recorders, hard disk drive recorders, and portable music players, a car navigation system, and the like.

The graphic user interface uses a pointing device as an input apparatus. The most popular pointing device is a mouse, but such a pointing device as a trackball, a touch panel, and a joy stick is also common.

In the normal trackball, the ball and the operation switch are separately disposed. Thus, normally, a user sequentially touches the two operation elements, i.e. the ball and the operation switch in the trackball in order, to thereby operate an operated apparatus such as a recorder and a personal computer.

For example, when operating the personal computer which uses the graphic user interface with the normal trackball, the user firstly rotates the ball provided for the trackball with the finger, to thereby displace a pointer displayed in the screen onto an icon. Then, the user presses (e.g. clicks or double-clicks) the operation switch disposed away from the ball in the trackball. By this, a process related to the icon is performed.

On the other hand, Japanese Patent Application Laid Open NO. Hei 1-290021 discloses such a trackball that both the displacement of the pointer and the process related to the icon can be performed only by touching the ball.

In the trackball, the operation switch is disposed under the ball. Moreover, the trackball works such that when the ball is pressed by the user and the ball is displaced downward, the operation switch is pressed by the ball. If using such a trackball, the user firstly rotates the ball, to thereby displace the pointer displayed in the screen onto the icon and then press the ball. Only by this, the process related to the icon is performed.

On the other hand, Japanese Patent Application Laid Open NO. 2000-311052 discloses a point device having such a mechanism that the operation switch is disposed on the lower side of a touch pad, which can vertically move, and that the operation switch is pressed by the touch pad being pressed.

Patent document 1: Japanese Patent Application Laid Open NO. Hei 1-290021
Patent document 2: Japanese Patent Application Laid Open NO. 2000-311052

### DISCLOSURE OF INVENTION

### Subject to be Solved by the Invention

By the way, as in the trackball disclosed in Japanese Patent Application Laid Open NO. Hei 1-290021, in the trackball of a type that the ball is pressed to press the operation switch, the ball rotates when the user presses the ball, and thus the position of the pointer in the screen is sometimes shifted. In this case, the user's intentional process is no longer performed in the operated apparatus. Such a situation leads to low operability of the graphic user interface, which is not preferable.

Such a position shift can also occur in another pointing device having a structure which allows the pointer to be displaced and the operation switch to be pressed only by the user touching one operation element, such as the touch pad disclosed in Japanese Patent Application Laid Open NO. 2000-311052.

Moreover, such a position shift occurs more easily if the user operates the pointing device with it lifted up by the hand than if the user operates the pointing device with it placed on a desk. For example, if the user operates a remote controller provided with the pointing device (hereinafter referred to as a “remote controller”), the position shift of the pointer easily occurs.

On the other hand, as in the normal trackball and the mouse, even in the pointing device of a type that the ball and the operation switch are separately disposed and that the user separately touches the two operation elements to operate the operated apparatus, the ball and the mouse move when the user presses the operation switch, which may result in the shift in the position of the pointer in the screen.

In view of the aforementioned problems, it is therefore a first object of the present invention to provide an input control apparatus, an input control method, and a computer program, which can prevent a user's intentional process from not being performed because of the displacement of an indication mark such as a pointer and a highlight, generated when a user presses an operation switch, and which can thus increase the operability of a user interface, a pointing device, or an operated apparatus.

It is a second object of the present invention to provide an input control apparatus, an input control method, and a computer program, which can increase the operability of a pointing device having a structure which allows the indication mark to be displaced and the operation switch to be pressed only by the user touching one operation element.

### Means for Solving the Subject

The above object of the present invention can be achieved by an input control apparatus, according to claim 1, for controlling displacement of an indication position in a screen and execution of a process related to the indication position in accordance with an operation of a pointing device, the input control apparatus provided with: a receiving device for receiving a displacement control signal for displacing the indication position and an operation switch signal which indicates that an operation switch disposed on the pointing device is pressed, from the pointing device; a coordinate data generating device for generating coordinate data which indicates the indication position after displacement on the basis of the displacement control signal received by the receiving device; a displaying device for displaying an indication mark on the indication position after the displacement indicated by the coordinate data generated by the coordinate data generating device; a first accumulating device for accumulating the coordinate data generated by the coordinate data generating device; and an executing device for reading the coordinate data generated a predetermined time point before a time point that the operation switch signal is received, from the first accumulating device and performing a process related to the indication position in the past indicated by the coordinate data, when the operation switch signal is received by the receiving device.

The above object of the present invention can be also achieved by an input control method, according to claim 6, of controlling displacement of an indication position in a screen and execution of a process related to the indication position in accordance with an operation of a pointing device, the input control method provided with: a first receiving process of receiving a displacement control signal for displacing the indication position from the pointing device; an accumulating process of accumulating coordinate data which indicates the indication position after displacement, generated on the basis of the displacement control signal received in the first receiving process, into a memory apparatus; a second receiving process of receiving an operation switch signal which indicates that an operation switch disposed on the pointing device is pressed; and an executing process of reading the coordinate data generated a predetermined time point before a time point that the operation switch signal is received, from the memory apparatus and performing a process related to the indication position in the past indicated by the coordinate data, when the operation switch signal is received in the second receiving process.

The above object of the present invention can be also achieved by a computer program, according to claim 7, for making a computer perform the input control method according to claim 6.

### BRIEF DESCRIPTION OF DRAWINGS

FIG. 1 is a perspective view showing a recorder, a remote controller, and a display apparatus.

FIG. 2 is an explanatory diagram showing a menu, a pointer, and icons displayed on a screen of the display apparatus in FIG. 1.

FIG. 3 is an explanatory diagram showing an aspect that an indication position (or pointer) moves toward the icon in the screen of the display apparatus in FIG. 2.

FIG. 4 is a block diagram showing the inner structure of a recorder, which is a first embodiment of the input control apparatus of the present invention.

FIG. 5 is a block diagram showing an input/output control circuit, which is a more specific embodiment of the input/output control device in FIG. 4.

FIG. 6 is a flowchart showing a position shift cancel process in the recorder in FIG. 4.

FIG. 7 is a block diagram showing the inner structure of the remote controller in FIG. 1.

FIG. 8 is a cross sectional view showing the remote controller observed in the arrow A-A direction in FIG. 1.

FIG. 9 is a block diagram showing the inner structure of a recorder, which is a second embodiment of the input control apparatus of the present invention.

FIG. 10 is a graph showing a change in the displacement velocity of the indication position.

FIG. 11 is a graph showing a change in the displacement velocity of the indication position.

FIG. 12 is a graph showing a change in the displacement velocity of the indication position.

FIG. 13 is a graph showing a change in the displacement velocity of the indication position.

FIG. 14 is a graph showing a change in the displacement velocity of the indication position.

FIG. 15 is a graph showing a change in the displacement velocity of the indication position.

FIG. 16 is a flowchart showing a position shift cancel process in the recorder in FIG. 9.

### DESCRIPTION OF REFERENCE CODES

1, 70 recorder
2A screen
15 pointer
20, 80 input/output control device
21, 81 communication device
22, 82 coordinate data generation device
23, 83 pointer display device
24, 85 memory device
25, 86 execution control device
26, 87 total control device
50 trackball
51 ball
54 operation switch
84 displacement velocity calculation device

### BEST MODE FOR CARRYING OUT THE INVENTION

Hereinafter, embodiments of the present invention will be explained with reference to the drawings.

### FIRST EMBODIMENT

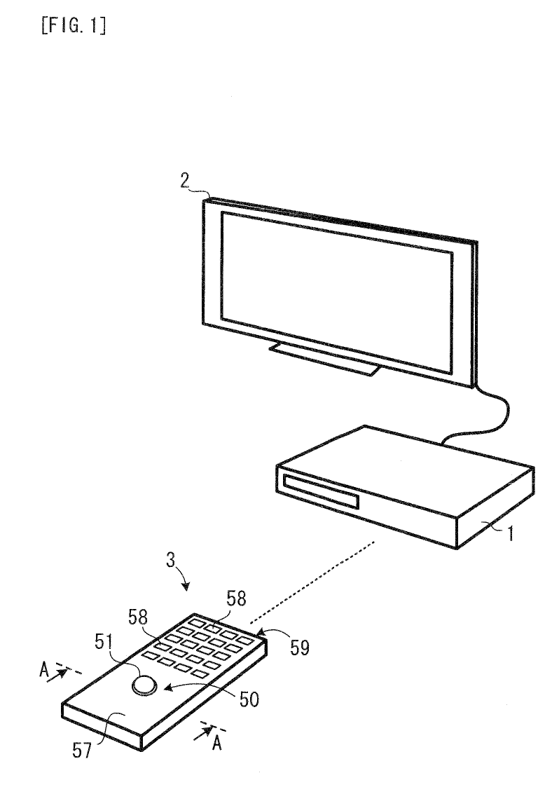

FIG. 1 shows a recorder, a remote controller, and a display apparatus.

A recorder 1 in FIG. 1 is a first embodiment of the input control apparatus of the present invention. The recorder 1 is, for example, a hard disk drive recorder with a built-in television tuner. The recorder 1 has a normal function as the recorder: a function of receiving program content data transmitted from a television broadcast station and storing it onto a hard disk. The recorder 1 also has a graphic user interface function for operating the recorder 1. The recorder 1 also has a position shift cancel function described later. Moreover, a display apparatus 2 is connected to the recorder 1.

A remote controller 3 is an apparatus for remotely operating the recorder 1. The remote controller 3 has a function of wirelessly communicating with the recorder 1 through radio waves and uses the radio waves to remotely control the recorder 1. Moreover, the remote controller 3 is provided with a trackball 50. A user can operate the recorder 1 with the trackball 50 and the graphic user interface function of the recorder 1. Incidentally, the recorder 1 and the remote controller 3 constitute an input control system.

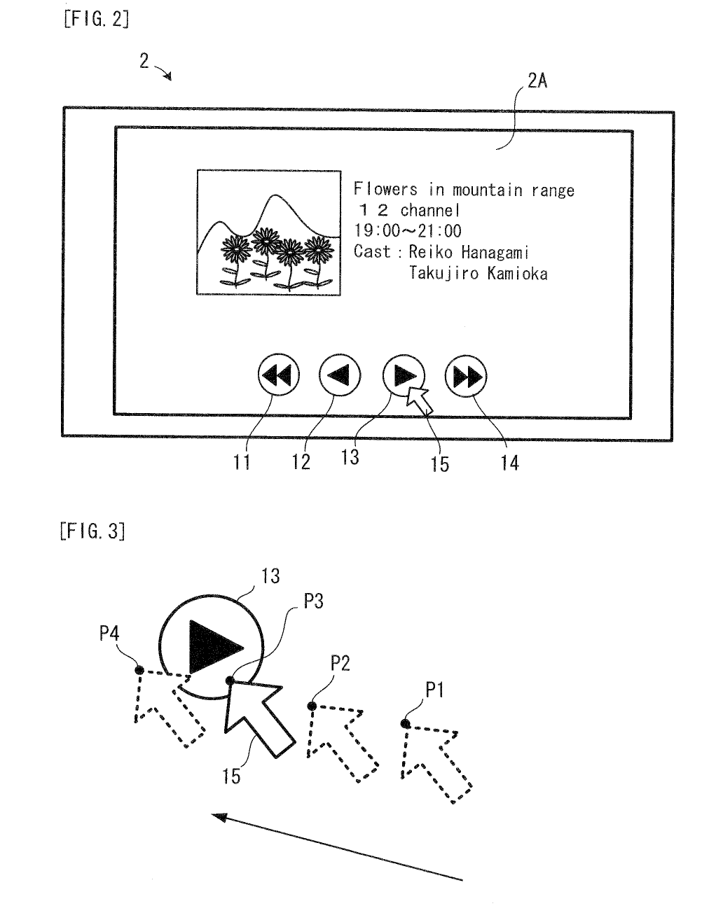

FIG. 2 shows a menu, a pointer, icons, and the like displayed on a screen of a display apparatus 2. From now, the graphic user interface function of the recorder 1 will be explained with reference to FIG. 2.

As shown in FIG. 2, for example, when the user is allowed to select a television program to be received by the recorder 1, a program content stored in the recorder 1, or the like, the recorder 1 displays the menu on a screen 2A of the display apparatus 2. The recorder 1 also displays icons 11, 12, 13, and 14 which denote, for example, buttons for changing a menu page. Moreover, the recorder 1 displays a pointer 1.5 which indicates an indication position in the screen 2A.

The user can displace the indication position by rotating a ball 51 of the trackball 50 provided for the remote controller 3. The recorder 1 displaces the pointer 15 in the screen so that the indication position matches the position indicated by the pointer 15.

When the user rotates the ball 51 of the trackball 50 to displace the indication position onto any of the icons and presses the ball 51 to press an operation switch 54 (refer to FIG. 8), the recorder 1 performs a process assigned to the icon. For example, as shown in FIG. 2, when the user rotates the ball 51, displaces the indication position onto the icon 13, and presses the ball 51, the recorder 1 changes the menu page.

FIG. 3 shows an aspect that the indication position (or pointer) moves toward the icon in the screen 2A of the display apparatus 2. From now, the position shift cancel function of the recorder 1 will be explained with reference to FIG. 3.

The position shift cancel function is a function of substantially cancelling the position shift of the indication position, caused when the operation switch 54 of the trackball 50 (or the pointing device) is pressed.

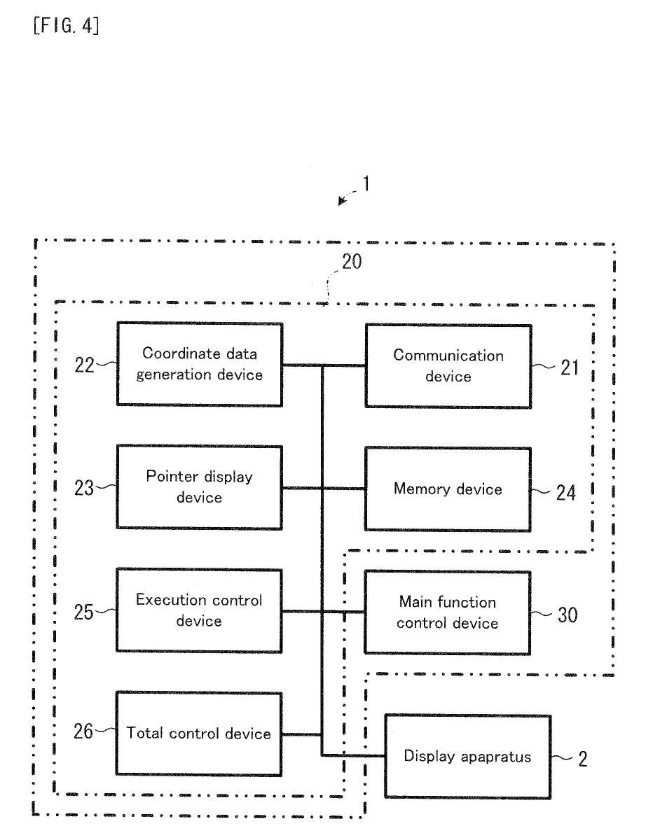

In order to realize the position shift cancel function, the recorder 1. accumulates coordinate data, which indicates the indication position in the screen 2A, in a memory device 24 (refer to FIG. 4), and when the operation switch 54 of the trackball is turned on, the recorder 1 reads the coordinate data that is generated a predetermined retrospective time before about this time point from the memory device 24 and performs a process related to the indication position in the past indicated by the coordinate data.

The retrospective time is set to a time from when the user finishes an action of displacing the indication position onto the desired icon by rotating the ball 51 of the trackball 50 to when the operation switch 54 is turned on. In general, the shortest time between the user confirming that the indication position is determined on the desired icon and the user turning on the operation switch 54 is approximately 200 milliseconds (ms) in view of the reflex reaction time of people. In other words, in case of the operation by the graphic user interface, the user confirms the pointing on the screen and then presses the operation switch. Thus, the shortest time spent for the confirmation and the press of the switch is approximately 200 milliseconds, which is said to be the shortest reaction time of people. Therefore, even if the position of the pointing is changed within 200 milliseconds immediately before the switch is pressed, people cannot confirm the change, so the change can be considered not to be based on ones' intentions. Thus, in the recorder 1, the retrospective time is set to 200 milliseconds. The retrospective time may be nevertheless adjusted within a range of approximately 100 milliseconds to 1 second, in view of individual differences.

According to the position shift cancel function, when the operation switch 54 of the trackball 50 is turned on, it performs a process related not to the actual indication position at this time point but to the indication position at the time point that the user finishes the action of displacing the indication position; namely, it substantially cancels the displacement of the indication position from the time point that the user finishes the action of displacing the indication position to the time point that the operation switch 54 is turned on, i.e. the position shift.

For example, as shown in FIG. 3, when the user inputs an intention to perform the process assigned to the intended icon 13, to the recorder 1, the user firstly rotates the ball 51 of the trackball 50, to thereby displace the indication position (or pointer 15) onto the icon 13 in the screen 2A. In this process, the indication position moves from P1, P2, to P3. Then, the user confirms that the indication position is on the icon 13 and then presses the ball 51 to turn on the operation switch 54.

It is assumed that the ball 51 rotates when the user presses the ball 51. It is also assumed that the indication position moves from P3 to P4 because of the rotation of the ball 51 and thus the indication position is off from the icon 13, and that the operation switch 54 is turned on when the indication position is at the position P4, which is away from the icon 13.

However, the displacement of the indication position from P3 to P4 is substantially canceled by the position shift cancel function of the recorder 1.

In other words, when the operation switch 54 is turned on, the recorder 1 reads the coordinate data that is generated 200 milliseconds before about the time point that the operation switch 54 is turned on from the memory device 24 and performs the process related to the indication position indicated by the coordinate data. The indication position of 200 milliseconds before about the time point that the operation switch 54 is turned on is the position P3 on the icon 13. Therefore, the indication position indicated by the coordinate data read from the memory device 24 is the position P3. As a result, the process related to the position P3, i.e. the process related to the icon 13 is performed.

FIG. 4 shows the inner structure of the recorder 1.

As shown in FIG. 4, the recorder 1 is provided with an input/output control device 20 and a main function control device 30.

The input/output control device 20 controls the displacement of the indication position in the screen 2A of the display apparatus and the execution of the process related to the indication position, in accordance with the operation of the trackball 50 of the remote controller 3. In other words, the input/output control device 20 realizes the graphic user interface function of the recorder 1. The input/output control device 20 also performs the position shift cancel process. By virtue of the position shift cancel process, the position shift cancel function is realized.

The main function control device 30 is a portion in which the normal function of the recorder 1 as the recorder is realized.

The input/output control device 20 is provided with a communication device 21, a coordinate data generation device 22, a pointer display device 23, the memory device 24, an execution control device 25, and a total control device 26.

The communication device 21 performs wireless communication by radio waves with the remote controller 3. Specifically, the communication device 21 receives a displacement control signal and an operation switch signal from the remote controller 3. The communication device 21 is provided with, for example, a radio wave reception circuit and a radio wave transmission circuit.

The displacement control signal is a control signal for displacing the indication position in the screen 2A of the display apparatus 2. For example, the displacement control signal includes a control signal which indicates a travel distance of the indication position in the lateral direction in the screen 2A and a control signal which indicates a travel distance of the indication position in the longitudinal direction in the screen 2A. More specifically, the displacement control signal includes a pulse signal which indicates an amount of rotation in the X direction of the ball 51 of the trackball 50 and a pulse signal which indicates an amount of rotation in the Y direction of the ball 51 of the trackball 50.

The operation switch signal is a control signal which indicates that the operation switch 54 of the trackball 50 is pressed, and one example is a pulse signal. As described later, in the trackball 50, the operation switch 54 is disposed under the ball 51, and the operation switch 54 is tuned on by pressing the ball 51.

The coordinate data generation device 22 generates the coordinate data which indicates the indication position after the displacement, on the basis of the displacement control signal received by the communication device 21.

The coordinate data denotes a position in the screen 2A, from the combination of a numerical value which indicates a position in the lateral direction (X direction) of the screen 2A and a numerical value which indicates a position in the longitudinal direction (Y direction) of the screen 2A.

The pointer display device 23 displays the pointer on the indication position after the displacement, indicated by the coordinate data generated by the coordinate data generation device 22. The pointer display device 23 performs a pointer display process every time at least the coordinate data is updated such that the indication position matches the position indicated by the pointer. By this, if the indication position moves, the pointer also moves following the indication position.

The memory device 24 accumulates the coordinate data generated by the coordinate data generation device 22. The memory device 24 is, for example, a RAM (Random Access Memory).

The memory device 24 stores the coordinate data at predetermined memory unit time intervals. The memory device 24 also stores the coordinate data such that the storage order is clear. The memory device 24 also holds the coordinate data from the current time point to the predetermined retrospective time ago. For example, the memory device 24 has a ring buffer structure formed, and the old coordinate data before the retrospective time is deleted every time the new coordinate data is stored.

For example, if the memory unit time is 20 milliseconds and the retrospective time is 200 milliseconds, the coordinate data is stored every 20 milliseconds into the memory device 24. Moreover, the memory device 24 holds eleven coordinate data stored from the current time point to the 200 milliseconds ago. In the memory device 24, the stored eleven coordinate data is arranged so that the ring buffer structure is formed in accordance with the stored order, and the coordinate data stored 220 milliseconds before the current time point every time the new coordinate data is stored.

The execution control device 25 reads the coordinate data generated the predetermined retrospective time before the time point that the operation switch signal is received from the memory device 24 when the operation switch signal is received by the communication device 21, and performs the process related to the indication position in the past indicated by the coordinate data.

The data which indicates the retrospective time is stored in a ROM or the memory device 24. The execution control device 25 reads the data which indicates the retrospective time from the ROM or the memory device 24 and determines the coordinate data to be read from the memory device 24 on the basis of the data.

The total control device 26 controls the constituent elements 21 to 25 of the input/output control device 20. For example, the total control device 26 performs control of storing the coordinate data into the memory device 24, or similar control.

The coordinate data generation device 22, the pointer display device 23, the execution control device 25, and the total control device 26 are formed of, for example, a CPU (Central Processing Unit), a ROM (Read Only Memory), a RAM or the like. In other words, the ROM stores a program which describes commands or the like to realize the functions of the coordinate data generation device 22, the pointer display device 23, the execution control device 25, and the total control device 26. The CPU reads the program from the ROM and executes it. The CPU also uses the RAM as a working memory or the like when executing the program.

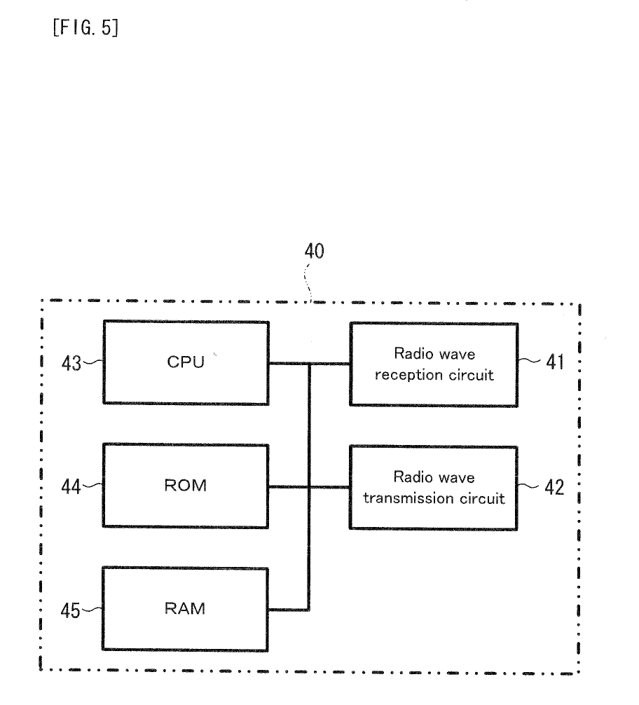

FIG. 5 shows an input/output control circuit, which is a more specific embodiment of the input/output control device 20.

In an input/output control circuit 40 in FIG. 5, a radio wave reception circuit 41 and a radio wave transmission circuit 42 are specific examples of the communication device 21. Moreover, a CPU 43, a ROM 44, and a RAM 45 are specific examples of the coordinate data generation device 22, the pointer display device 23, the execution control device 25, and the total control device 26. The RAM 45 is also a specific example of the memory device 24.

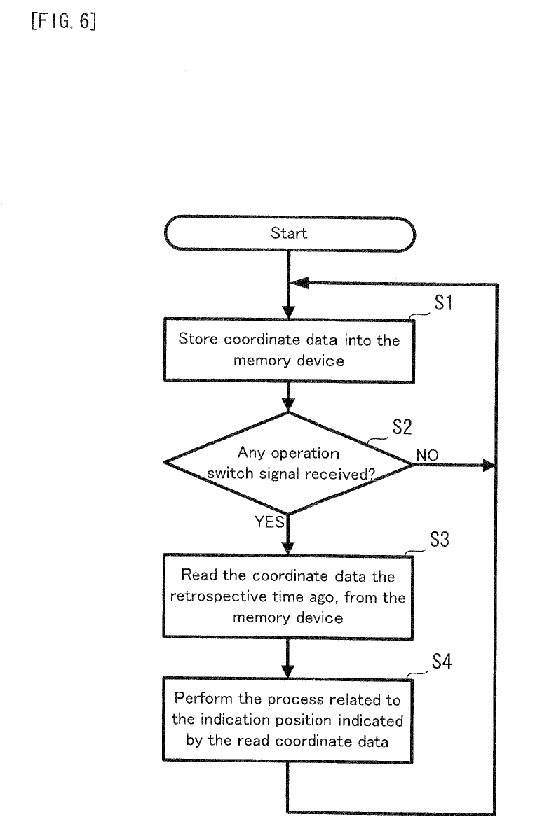

FIG. 6 shows a flow of the position shift cancel process in the recorder 1.

The position shift cancel process is performed by the input/output control circuit 20 while the function of the graphic user interface of the recorder 1 is activated.

Firstly, the coordinate data generation device 22 generates the coordinate data which indicates the indication position after the displacement, on the basis of the displacement control signal received by the communication device 21. The pointer display device 23 displays the pointer on the indication position, indicated by the coordinate data generated by the coordinate data generation device 22.

Then, the total control device 26 stores the coordinate data generated by the coordinate data generation device 22, into the memory device 24 (step S1 in FIG. 6).

Then, the total control device 26 judges whether or not the operation switch signal is received by the communication device 21 (step S2). Then, the total control device 26 repeats the step S1 and the step S2 until the operation switch signal is received.

When the operation switch signal is received (the step S2: YES), the execution control device 25 reads the coordinate data of the predetermined retrospective time ago, from the memory device 24 (step S3).

Then, the execution control device 25 performs the process related to the indication position indicated by the read coordinate data (step S4).

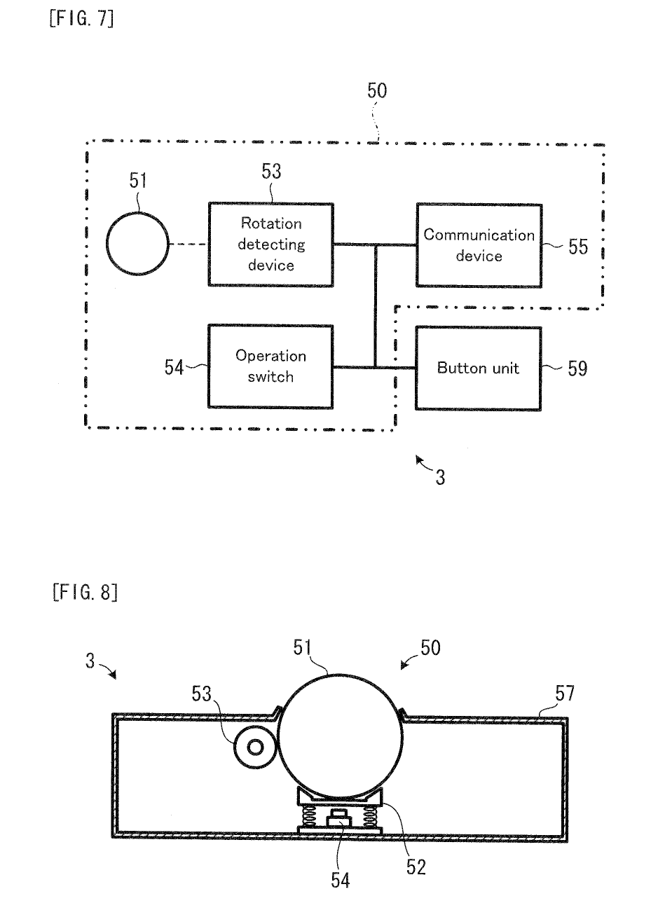

FIG. 7 shows the inner structure of the remote controller 3. FIG. 8 shows the cross section of the remote controller 3 observed in the arrow A-A direction in FIG. 1.

As shown in FIG. 7, the remote controller 3 is provided with the trackball 50; and a button unit 59, which is provided with a plurality of buttons 58 (refer to FIG. 1), a switch circuit, and the like.

The trackball 50 is a pointing device, and also an input apparatus for realizing the graphic user interface function of the recorder 1. The user can remotely operate the recorder 1 by operating the trackball 50 and the buttons 58.

The trackball 50 is provided with the ball 51, a ball support device 52, a rotation detecting device 53, the operation switch 54, and a communication device 55.

The ball 51, as shown in FIG. 8, is a sphere and is rotatably supported between a case 57 of the remote controller 3 and the ball support device 52.

The rotation detecting device 53 detects the amount of rotation in the

X direction and the amount of rotation in the Y direction of the ball 51, and generates the displacement control signal corresponding to the amounts of rotation. The rotation detecting device 53 is provided with a detector for detecting the amount of rotation of the ball 51 in the X direction and a detector for detecting the amount of rotation of the ball 51 in the Y direction. Each of the detectors is provided with a roller, which is in contact with the surface of the ball 51 and which rotates when the ball 51 rotates; and a signal generation circuit for generating a pulse signal having the number of pulses that correspond to the amount of rotation of the roller. In this case, the pulse signal generated by each signal generation circuit is the displacement control signal. Incidentally, an optical detector may be used as each of the detectors of the rotation detecting device 53.

The operation switch 54 is disposed under the ball 51. When the ball 51 is pressed, the operation switch 54 is turned on. In other words, the ball 51 is supported by the ball support device 52, movably in the vertical direction. An elastic force is applied to the ball 51 upward by springs placed on the ball support device 52. When the user presses the ball 51 downward, the ball 51 is displaced downward against the springs. As a result, the operation switch 54 is pressed, and the operation switch 54 is turned on. When the operation switch 54 is turned on, the operation switch signal is outputted from the operation switch 54.

The communication device 55 performs wireless communication by radio waves with the communication device 21 of the recorder 1. The communication device 52 is formed of, for example, a radio wave transmission circuit and a radio wave reception circuit. The displacement control signal and the operation switch signal are transmitted to the recorder 1 through the communication device 55.

As explained above, the recorder 1 generates the coordinate data which indicates the indication position in the screen 2A of the display apparatus 2 and accumulates the coordinate data into the memory device 24. When the operation switch signal is received, the recorder 1 reads the coordinate data generated the predetermined retrospective time before the time point that the operation switch signal is received from the memory device 24, and performs the process related to the indication position in the past indicated by the coordinate data. The retrospective time is set to a time from when the user finishes the action of displacing the indication position onto the desired icon by rotating the ball 51 of the trackball 50 to when the operation switch 54 is turned on.

By this, when the user presses the ball 51, the process related to the indication position at the time point that the user finishes the action of displacing the indication position onto the icon, i.e. the process related to the indication position on the icon (namely, the process related to the icon), is performed. As a result, even if the ball 51 rotates when the user presses the ball 51 and thus the indication position is off the desired icon, the process related to the icon is performed. Thus, the user can operate the recorder 1 as the user intends to.

As described above, according to the recorder 1, the operability of the recorder 1, the remote controller 3, and the trackball 50 can be improved.

Moreover, in the recorder 1, the retrospective time is set to approximately 100 milliseconds to 1 second. This time corresponds to the time from when the user finishes the action of displacing the indication position onto the desired icon by rotating the ball 51 of the trackball 50 to when the operation switch 54 is turned on. By this, it is possible to accurately identify the time point that the user finishes the action of displacing the indication position onto the icon. Therefore, the process related to the icon the user intends can be performed with certainty when the user presses the ball 51.

Moreover, by setting the retrospective time to approximately 200 milliseconds, it is possible to more accurately identify the time point that the user finishes the action of displacing the indication position onto the icon. Therefore, the process related to the icon the user intends can be performed with more certainty when the user presses the ball 51.

In the input control system, the trackball 50 is provided for the remote controller 3, whereas the recorder 1 is provided with the communication device 21 for communicating with remote controller 3. The user lifts up the remote controller 3 with the hand, rotates the ball 51 provided for the remote controller 3, and presses the ball 51, to thereby operate the recorder 1.

For example, in comparing a case where the ball 51 is pressed with the remote controller 3 placed on a desk and a case where the ball 51 is pressed with the remote controller 3 lifted up, the ball 51 easily rotates when the ball 51 is pressed if the ball 51 is pressed with the remote controller 3 lifted up.

According to the recorder 1, however, even if the ball 51 rotates when the ball 51 is pressed, the user can perform the process related to the desired icon with certainty. Therefore, according to the recorder 1, the user can ensure the operation of the recorder 1 even when operating the recorder 1 with the remote controller 3 lifted up. Thus, it is possible to improve the operability of the remote controller 3 and the recorder 1 using the remote controller 3.

### SECOND EMBODIMENT

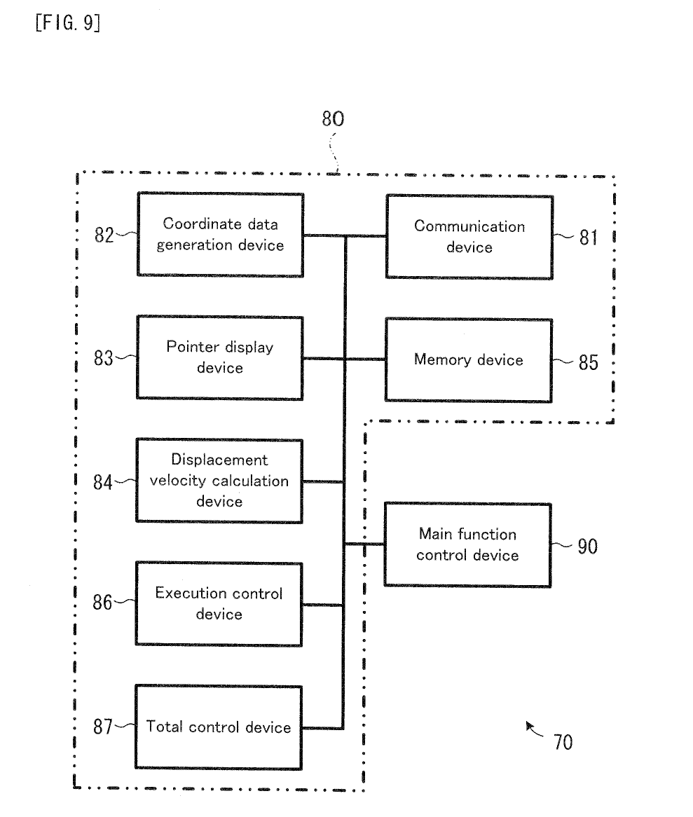

FIG. 9 shows the inner structure of a recorder, which is a second embodiment of the input control apparatus of the present invention.

A recorder 70 in FIG. 9 has the position shift cancel function. The method of realizing the position shift cancel function of the recorder 70 is different from that of the recorder 10 in FIG. 4.

In order to realize the position shift cancel function, the recorder 70 accumulates the coordinate data which indicates the indication position in the screen 2A and displacement velocity data which indicates a displacement velocity of the indication position, in a memory device 85. When the operation switch 54 of the trackball 50 is turned on and thus the operation switch signal is received, the recorder 70 reads the coordinate data generated at a certain time point which is the predetermined retrospective time before the time point that the operation switch signal is received and at which the displacement velocity of the indication position is a predetermined reference velocity or less, from the memory device 85, and the recorder 70 performs the process related to the indication position in the past indicated by the coordinate data, as a general rule.

The retrospective time is set to a time from when the user finishes an action of displacing the indication position onto the desired icon by rotating the ball 51 of the trackball 50 to when the operation switch 54 is turned on. Specifically, the retrospective time is set to approximately 100 milliseconds to 500 milliseconds, and desirably 200 milliseconds.

The reference velocity is preferably zero millimeters/second. A range of the slow displacement velocity in which the indication position can be judged to substantially remain stationary may be determined, and the upper limit of the displacement velocity range may be set as the reference velocity.

Moreover, a retrospective limit time is set for the recorder 70. The retrospective limit time is longer than the retrospective time, for example, approximately 1 second to several seconds.

For example, as shown in FIG. 3, when the user inputs an intention to perform the process assigned to the intended icon 13, to the recorder 1, the user firstly rotates the ball 51 of the trackball 50, to thereby displace the indication position (or pointer 15) onto the icon 13 in the screen 2A. In this process, the indication position moves from P1, P2, to P3. Then, the user confirms that the indication position is on the icon 13 and then presses the ball 51 to turn on the operation switch 54. It is assumed that the ball 51 rotates when the user presses the ball 51. It is also assumed that the indication position moves from P3 to P4 because of the rotation of the ball 51 and thus the indication position is off from the icon 13, and that the operation switch 54 is turned on when the indication position is at the position P4, which is away from the icon 13.

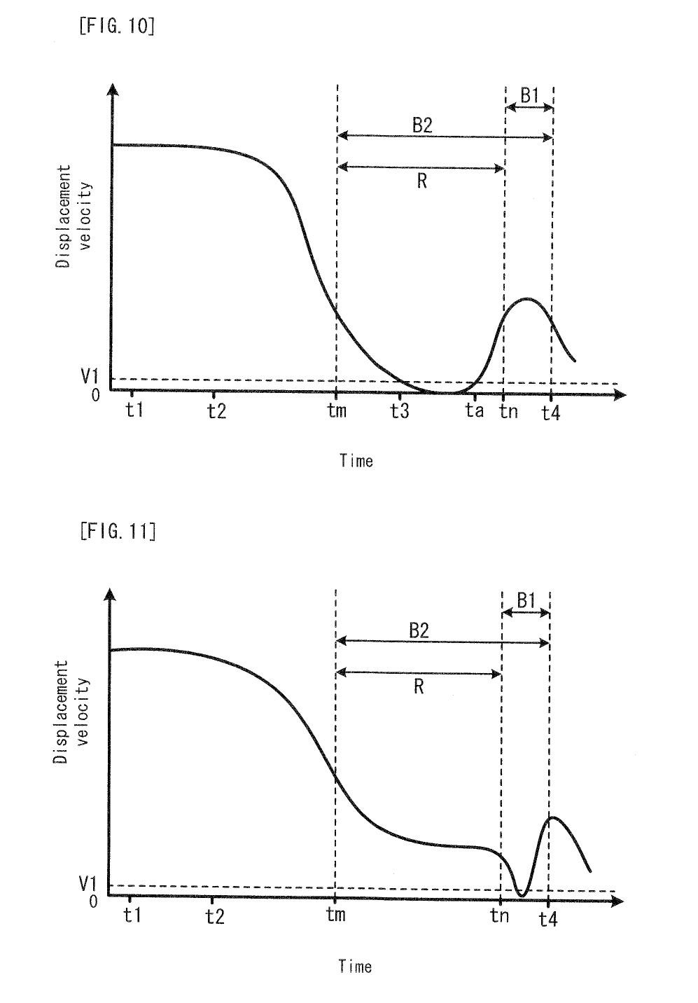

When the indication position moves from P1 to P4, the displacement velocity of the indication position usually changes as shown in FIG. 10. In FIG. 10, t1, t2, t3, and t4 correspond to the indication positions P1, P2, P3, and P4, respectively. As shown in FIG. 10, during a period of the time points t1 to t2, i.e. while the indication position moves from P1 to P2, the displacement velocity of the indication position is high (or fast) and substantially constant. Then, during a period of the time points t2 to t3, i.e. while the indication position moves from P2 to P3, the displacement velocity of the indication position becomes small (or slow). Then, the indication position becomes substantially stationary on the position P3 of the icon at the time point t3. Then, the user presses the ball 51 at a time point ta. At this time, if the ball 51 rotates and thus the indication position is displaced from P3 to P4, the displacement velocity of the indication position becomes high (or fast) after the time point ta. Then, the operation switch 54 is turned on at the time point t4.

As is seen from FIG. 10, during a period from when the user displaces the indication position onto the position P3 on the icon 13 to when the user starts the press of the ball 51, i.e. during a period from the time point t3 to the time point ta, the indication position remains substantially stationary on the icon 13. The recorder 70 finds a time point included in the period from the time point t3 to the time point t4, using such a condition that the time point is a retrospective time B1 or more before the time point that the operation switch signal is received (or the time point t4 that the operation switch is turned on) and such a condition that the displacement velocity of the indication position is a reference velocity V1 or less. Then, the recorder 70 reads the coordinate data generated at the relevant time point included in the period from the time point t3 to the time point ta, from the memory device 85, and the recorder 70 performs the process related to the indication position indicated by the coordinate data. The indication position indicated by the coordinate data generated at the time point included in the period from the time point t3 to the time point ta is on the icon 13. As a result, the process performed by the recorder 70 is the process related to the icon 13. Incidentally, FIG. 10 provides an example in which the upper limit of the displacement velocity slow enough to judge that the indication position remains substantially stationary is set to the reference velocity V1.

According to the position shift cancel function of the recorder 70, the displacement of the indication position from P3 to P4 can be substantially canceled.

The position shift cancel function of the recorder 70 will be explained, more specifically.

As shown in FIG. 10, it is assumed that the displacement velocity of the indication position becomes the reference velocity V1 or less within a range R (from a time point tm to a time point tn), which is the retrospective time B1 or more before the time point t4 but not exceeding a retrospective limit time B2 before the time point t4. In this case, the recorder 70 selects, for example, the time point ta that is closest to the time point tn, from the time points at which the displacement velocity of the indication position is the reference velocity V1 or less. Then, the recorder 70 reads the coordinate data generated at the time point ta from the memory device 85 and performs the process related to the indication position indicated by the coordinate data.

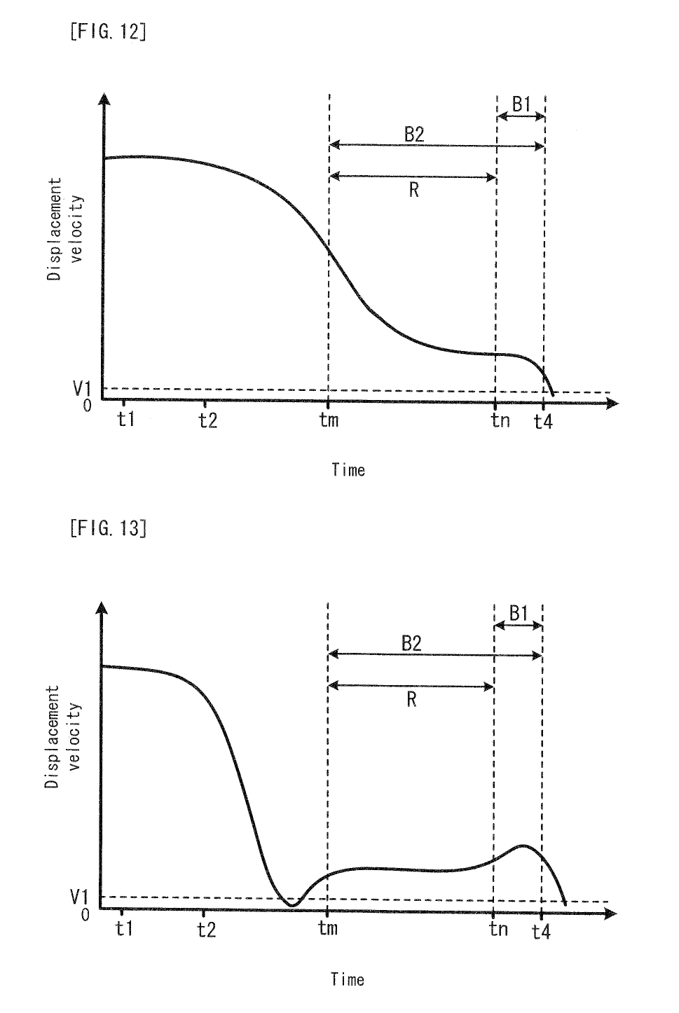

Moreover, as shown in FIG. 11, FIG. 12, and FIG. 13, it is also assumed that the displacement velocity does not become the reference velocity V1 or less within the range R. In this case, the recorder 70 selects, for example, the time point tn, which is the retrospective time B1 before the time point t4. Then, the recorder 70 reads the coordinate data generated at the time point tn from the memory device 85 and performs the process related to the indication position indicated by the coordinate data.

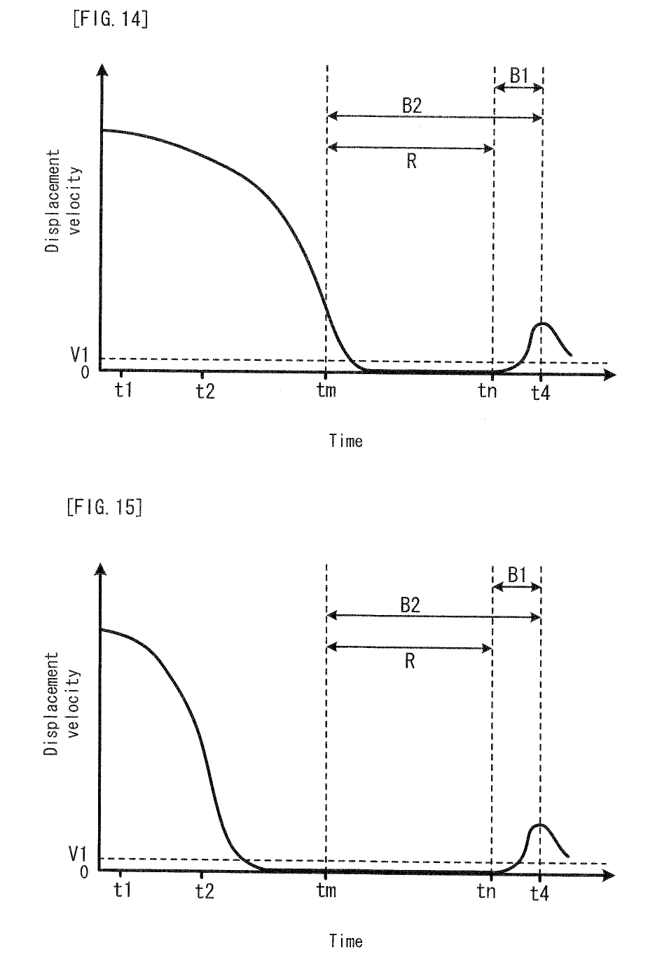

Moreover, as shown in FIG. 14 and FIG. 15, it is assumed that the displacement velocity of the indication position continues to be the reference velocity V1 or less until immediately before the time point t4. In this case, the recorder 70 selects, for example, the time point tn, which is the retrospective time B1 before the time point t4. Then, the recorder 70 reads the coordinate data generated at the time point tn from the memory device 85 and performs the process related to the indication position indicated by the coordinate data.

By the way, as shown in FIG. 9, the recorder 70 is provided with a communication device 81, a coordinate data generation device 82, a pointer display device 83, a displacement velocity generation device 84, the memory device 85, an execution control deice 86, and a total control device 87.

The communication device 81, the coordinate data generation device 82, and the pointer display device 83 are substantially the same as the communication device 21, the coordinate data generation device 22, and the pointer display device 23 in FIG. 4, respectively.

The displacement velocity generation device 84 calculates the displacement speed of the indication position, on the basis of a displacement control signal received by the communication device 81. For example, if the displacement control signal is a pulse signal having the number of pulses that correspond to the amount of rotation of the ball 51, the displacement velocity generation device 84 measures the number of pulses per predetermined unit time in the displacement control signal, to thereby calculate the displacement velocity of the indication position. The displacement velocity of the indication position is calculated at predetermined calculation unit time intervals. The calculation unit time is, for example, the same as the memory unit time in the memory device 85.

Incidentally, the displacement velocity of the indication position may be calculated on the basis of not the displacement control signal but the coordinate data generated by the coordinate data generation device 82. For example, a difference may be calculated between the coordinate data of the current indication position and the coordinate data of the indication position that is the predetermined unit time ago, i.e. the travel distance of the indication position per predetermined unit time, and the calculation result may be used as the displacement velocity of the indication position.

The memory device 85 accumulates therein the coordinate data generated by the coordinate data generation device 82 and the displacement velocity data which indicates the displacement velocity of the indication position calculated by the displacement velocity calculation device 84. The memory device 85 is, for example, a RAM.

The memory device 85 stores the coordinate data at predetermined memory unit time (approximately 20 milliseconds) intervals. The memory device 85 also stores the coordinate data such that the storage order is clear. The memory device 85 also holds the coordinate data from the current time point to a predetermined memory retention time (e.g. a time corresponding to the retrospective limit time) ago. For example, the memory device 85 has the ring buffer structure formed, and the old coordinate data before the memory retention time is deleted every time the new coordinate data is stored.

Moreover, the memory device 85 stores the displacement velocity data at predetermined memory unit time intervals. This memory unit time may be the same as the memory unit time used for the storage of the coordinate data. The memory device 85 also stores the displacement velocity data such that the storage order is clear. The memory device 85 also holds the displacement velocity data from the current time point to a predetermined memory retention time ago. This predetermined memory retention time may be the same as the predetermined memory retention time used for the storage of the coordinate data. For example, the memory device 85 has the ring buffer structure formed, and the old displacement velocity data before the memory retention time is deleted every time the new displacement velocity data is stored.

The execution control device 86 reads the coordinate data generated at a certain time point which is the predetermined retrospective time before the time point that the operation switch signal is received and at which the displacement velocity of the indication position is a predetermined reference velocity or less, from the memory device 85 on the basis of the displacement velocity data accumulated in the memory device 85 when the operation switch signal is received by the communication device 81, as a general rule. Then the execution control device 86 performs the process related to the indication position in the past indicated by the coordinate data.

The data which indicates the retrospective time, the data which indicates the reference velocity, and the data which indicates the retrospective limit time are stored in a ROM or the memory device 85. The execution control device 86 reads the data which indicates the retrospective time, the data which indicates the reference velocity, and the data which indicates the retrospective limit time from the ROM or the memory device 24 and determines the coordinate data to be read from the memory device 85 on the basis of those data.

The total control device 87 controls the constituent elements 81 to 86 of the input/output control device 80. For example, the total control device 87 performs control of storing the coordinate data and the displacement velocity data into the memory device 85, or similar control.

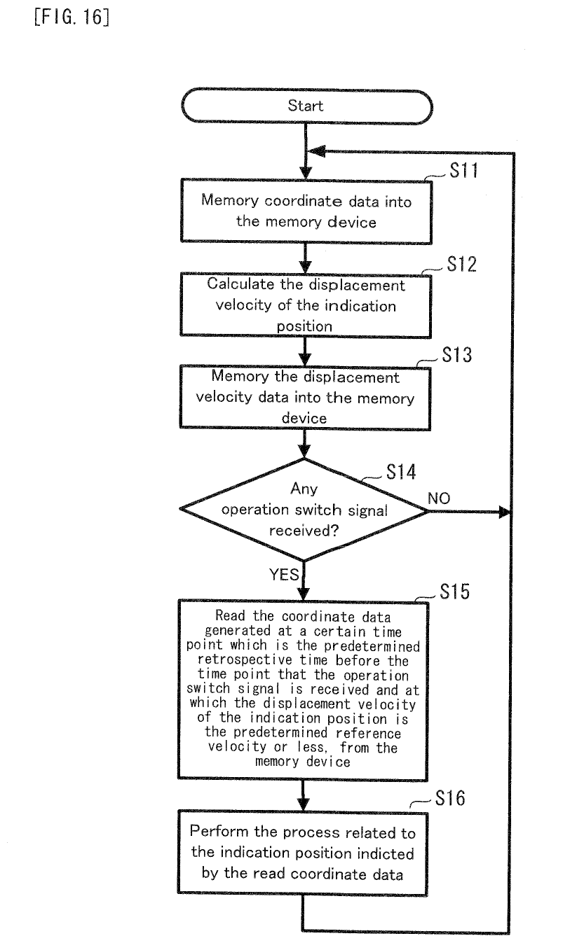

FIG. 16 shows the position shift cancel process in the recorder 70.

When the graphic user interface function of the recorder 70 is working, the coordinate data generation device 82 generates the coordinate data which indicates the indication position after the displacement, on the basis of the displacement control signal received by the communication device 81. The pointer display device 83 displays the pointer on the indication position indicated by the coordinate data generated by the coordinate data generation device 82.

Then, the total control device 87 stores the coordinate data generated by the coordinate data generation device 82, into the memory device 85 (step S11 in FIG. 16).

Then, the displacement velocity calculation device 84 calculates the displacement velocity of the indication position on the basis of the displacement control signal received by the communication device 81 (step S12).

Then, the total control device 87 stores the displacement velocity data which indicates the displacement velocity of the indication position calculated by the displacement coordinate data generation device 82, into the memory device 85 (step S13).

Then, the total control device 87 judges whether or not the operation switch signal is received by the communication device 81 (step S14). Then, the total control device 87 repeats the step S11 and the step S14 until the operation switch signal is received.

When the operation switch signal is received (the step S14: YES), the execution control device 86 reads the coordinate data generated at a certain time point (e.g. the time point to in FIG. 10) which is the predetermined retrospective time before the time point that the operation switch signal is received and at which the displacement velocity of the indication position is the predetermined reference velocity or less, from the memory device 85, as a general rule (step S15). Incidentally, if the change in the displacement velocity of the indication position has such a pattern as shown in FIG. 10, the execution control device 86 performs such a process; however, if the change in the displacement velocity of the indication position has such a pattern as shown in FIG. 11, FIG. 12, FIG. 13, FIG. 14, or FIG. 15, the execution control device 86 reads the coordinate data generated at the time point tm, which is the predetermined retrospective time B1 before the time point that the operation switch signal is received, from the memory device 85.

Then, the execution control device 86 performs the process related to the indication position indicated by the read coordinate data (step S16).

As explained above, the recorder 70 generates the coordinate data which indicates the indication position in the screen 2A of the display apparatus 2 and accumulates the coordinate data into the memory device 85. The recorder 70 also calculates the displacement velocity of the indication position and accumulates the displacement data which indicates the displacement velocity of the indication position, into the memory 85. When the operation switch signal is received, the recorder 70 reads the coordinate data generated at a certain time point which is the predetermined retrospective time before the time point that the operation switch signal is received and at which the displacement velocity of the indication position is the predetermined reference velocity or less, from the memory device 85, and the recorder 70 performs the process related to the indication position in the past indicated by the coordinate data, as a general rule.

By this, when the user presses the ball 51, the process related to the indication position at the time point that the user finishes the action of displacing the indication position onto the icon, i.e. the process related to the indication position on the icon (namely, the process related to the icon), is performed. As a result, even if the ball 51 rotates when the user presses the ball 51 and thus the indication position is off the desired icon, the process related to the icon is performed. Thus, the user can operate the recorder 70 as the user intends to.

As described above, according to the recorder 70, the operability of the recorder 70, the remote controller 3, and the trackball 50 can be improved.

Moreover, in the recorder 70, the reference velocity is set to approximately zero millimeters/second or the upper limit of the displacement velocity slow enough to judge that the indication position remains substantially stationary. The velocity corresponds to the displacement velocity of the indication position at the time point that the user finishes the action of displacing the indication position onto the desired icon by rotating the ball 51 and that the indication position remains substantially stationary on the icon. By this, it is possible to accurately identify the time point that the user finishes the action of displacing the indication position onto the icon. Therefore, the process related to the icon the user intends can be performed with certainty when the user presses the ball 51.

Incidentally, the present invention is not limited to the aforementioned hard disk drive recorder 1 but can be applied to AV equipment such as a DVD recorder and a portable music player. The present invention can be also applied to a car navigation system, a personal computer, or the like.

Moreover, the aforementioned explanation provides an example in which the trackball 50 is provided for the remote controller; however, the trackball is not necessarily provided for the remote controller, and it may be the trackball as one independent product.

Moreover, the aforementioned explanation provides the trackball 50 as one example of the pointing device; however, the pointing device may be a joystick, a mouse, and a touch pad.

Moreover, the aforementioned explanation provides an example in which the indication position is displaced onto the icon and the process related to the icon is performed; however, the present invention is not limited to this example. For example, the indication position may be displaced onto a character, a picture image, a point, or the like displayed in the screen, and a process related to the character, the picture image, the point, an item, or the like may be performed.

Moreover, the aforementioned explanation provides an example in which the pointer is displayed on the indication position in the screen; however, the present invention is not limited to this example. For example, the position indicated by the indication position may be highlight-displayed. Incidentally, each of the pointer and the highlight is a specific example of the indication mark.

Moreover, the aforementioned explanation provides an example in which the user rotates the ball 51 of the trackball 50, to thereby displace the indication position in the screen 2A. However, according to the input control system provided with the recorder 1 and the remote controller 3, the user can also input a numerical value to the recorder 1 or select a parameter, by rotating the ball 51. The present invention can be also applied to the input of the numerical value or the parameter selection. For example, on the basis of the control signal corresponding to the amount of rotation of the ball 51, numerical value data which indicates the inputted numerical value is generated, and the numerical value data is accumulated into the memory device 24. When the operation switch signal is received, the numerical value data generated a predetermined retrospective time before the time point that the operation switch signal is received is read from the memory device 24, and the numerical value in the past indicated by the numerical value data is regarded as the inputted numerical value on the basis of the user's intention. Then the numerical value is treated as the genuine input value.

Moreover, according to the input control system provided with the recorder 1 and the remote controller 3, it is also possible to perform the input such that the graphic user interface is changed by the user rotating the ball 51. For example, the input can be performed so as to change the display structure itself of the graphic user interface such as the position of an image or a change in the aspect on the screen. The present invention can be also applied to such input. In this case, for example, on the basis of a control signal corresponding to the amount of rotation of the ball 51, data which indicates the image position or image aspect is generated, and the data is accumulated into the memory device 24. When the operation switch signal is received, the data generated a predetermined retrospective time before the time point that the operation switch signal is received is read from the memory device 24, and the image position or image aspect in the past indicated by the data is regarded as the image position or image aspect inputted on the basis of the user's intention.

Moreover, the communication device 21 in FIG. 4 is a specific example of the receiving device. The coordinate data generation device 22 is a specific example of the coordinate data generating device. The pointer display device 23 is a specific example of the displaying device. The memory device 24 is a specific example of the first accumulating device. The execution control deice 25 is a specific example of the executing device. The communication device 21 is also a specific example of the wireless receiving device.

Moreover, the communication device 81 in FIG. 9 is a specific example of the receiving device. The coordinate data generation device 82 is a specific example of the coordinate data generating device. The pointer display device 83 is a specific example of the displaying device. The displacement velocity calculation device 84 is a specific example of the displacement velocity calculating device. The memory device 85 is a specific example of the first accumulating device and the second accumulating device. The communication device 81 is also a specific example of the wireless receiving device.

Moreover, the step S1 in FIG. 6 is a specific example of the accumulating process. The step S2 is a specific example of the second receiving process. The step S3 and the step S4 are specific examples of the executing process.

Moreover, the present invention can be realized as a computer program. In this case, such a computer program is prepared that describes commands or the like to realize the operations of the communication device 21, the coordinate data generation device 22, the pointer display device 23, the memory device 24, the execution control device 25, and the total control device 26 in FIG. 4, and the computer program is read by a computer. Alternatively, such a computer program is prepared that describes commands or the like to realize the operations of the communication device 81, the coordinate data generation device 82, the pointer display device 83, the displacement velocity calculation device 84, the memory device 85, the execution control device 86, and the total control device 87 in FIG. 9, and the computer program may be read by a computer. The present invention may be allowed to be realized as a computer program product or a recording medium on which such a computer program is recorded.

The present invention is not limited to the aforementioned embodiments, but various changes may be made, if desired, without departing from the essence or spirit of the invention which can be read from the claims and the entire specification. An input control apparatus and an input control method which involve such changes and a computer program which realizes such functions are also intended to be within the technical scope of the present invention.

### INDUSTRIAL APPLICABILITY

The present invention can be applied to manufacturing, sale, and use of equipment such as a DVD recorder, a portable music player, a car navigation system, and a personal computer, and a pointing device and a remote controller for operating such equipment.

1. An input control apparatus for controlling displacement of an indication position in a screen and execution of a process related to the indication position in accordance with an operation of a pointing device, said input control apparatus comprising:
a receiving device for receiving a displacement control signal for displacing the indication position and an operation switch signal which indicates that an operation switch disposed on the pointing device is pressed, from the pointing device;
a coordinate data generating device for generating coordinate data which indicates the indication position after displacement on the basis of the displacement control signal received by said receiving device;
a displaying device for displaying an indication mark on the indication position after the displacement indicated by the coordinate data generated by said coordinate data generating device;
a first accumulating device for accumulating the coordinate data generated by said coordinate data generating device; and
an executing device for reading the coordinate data generated a predetermined time point before a time point that the operation switch signal is received, from said first accumulating device and performing a process related to the indication position in the past indicated by the coordinate data, when the operation switch signal is received by said receiving device.

2. The input control apparatus according to claim 1, wherein the predetermined time ranges from 100 milliseconds to 1 second.

3. The input control apparatus according to claim 1, comprising:
a displacement velocity calculating device for calculating a displacement velocity of the indication position on the basis of the displacement control signal or the coordinate data; and
a second accumulating device for accumulating displacement velocity data which indicates the displacement velocity of the indication position calculated by said displacement velocity calculating device,
said executing device reading the coordinate data generated at a certain time point which is the predetermined time or more before the time point that the operation switch signal is received and at which the displacement velocity of the indication position is a predetermined velocity or less, from said first accumulating device on the basis of the displacement velocity data accumulated in said second accumulating device, and performing a process related to the indication position in the past indicated by the coordinate data, when the operation switch signal is received by said receiving device.

4. The input control apparatus according to claim 3, wherein said executing device reads the coordinate data generated at a certain time point which is the predetermined time or more before the time point that the operation switch signal is received and at which the displacement velocity of the indication position is substantially zero, from said first accumulating device on the basis of the displacement velocity data accumulated in said second accumulating device, and performs a process related to the indication position in the past indicated by the coordinate data, when the operation switch signal is received by said receiving device.

5. The input control apparatus according to claim 1, wherein said receiving device is a wireless receiving device for receiving the displacement control signal and the operation switch signal from the pointing device in a wireless manner.

6. An input control method of controlling displacement of an indication position in a screen and execution of a process related to the indication position in accordance with an operation of a pointing device, said input control method comprising:
a first receiving process of receiving a displacement control signal for displacing the indication position from the pointing device;
an accumulating process of accumulating coordinate data which indicates the indication position after displacement, generated on the basis of
the displacement control signal received in said first receiving process, into a memory apparatus;
a second receiving process of receiving an operation switch signal which indicates that an operation switch disposed on the pointing device is pressed; and
an executing process of reading the coordinate data generated a predetermined time point before a time point that the operation switch signal is received, from said memory apparatus and performing a process related to the indication position in the past indicated by the coordinate data, when the operation switch signal is received in said second receiving process.

7. A computer program for making a computer perform the input control method according to claim 6.
